(19) United States
(12) Patent Application Publication
(10) Pub. No.: US 2010/0162847 A1
(43) Pub. Date: Jul. 1, 2010

(54) ACTUATING MECHANISM FOR A PIVOTABLY MOUNTED ACTUATING ARM

(76) Inventor: Simon GASSNER, Dornbirn (AT)

Correspondence Address: WENDEROTH, LIND & PONACK, L.L.P., 1030 15th Street, N.W.,, Suite 400 East, Washington, DC, 20005-1503, US

(21) Appl. No.: 12/720,078

(22) Filed: Mar. 9, 2010

Related U.S. Application Data
(63) Continuation of application No. PCT/AT2008/000336, filed on Sep. 18, 2008.

(30) Foreign Application Priority Data
Sep. 28, 2007 (AT) A 1542/2007

(51) Int. Cl. A47B 96/00; G05G 11/00; E05F 15/10

(52) U.S. Cl. 74/490.07

(57) ABSTRACT

An actuating mechanism for a pivotably mounted actuating arm, in particular for driving a flap of an item of furniture, wherein the actuating arm is acted upon by a spring device, and wherein an electric drive acts on the actuating arm via a transmission mechanism, and wherein the transmission ratio of angle of rotation (α) of the motor to angle of rotation of the actuating arm is varied over the angle of rotation range of the actuating arm by the transmission mechanism.

The present invention relates to an actuating mechanism for a pivotably mounted actuating arm, in particular for driving a flap of an item of furniture, wherein the actuating arm is acted upon by a spring device, and wherein an electric drive acts on the actuating arm via a transmission mechanism.

The invention also relates to an item of furniture with an actuating mechanism of the kind described.

Actuating mechanisms of this kind are used for the purpose of driving flaps of items of furniture to move them from the closed position into the fully opened position, or vice versa. The actuating arm can be acted upon by a spring device in order for the weight of the flap to be compensated. The provision of an electric drive in addition to the acting spring device is also known, this electric drive serving to assist movement of the flap. The direct current motors used for this often operate at a substantially constant revolutionary speed with a relatively low torque. The spring device normally acts upon the flap in the closed position with a retaining force, which, to be surmounted in the open direction, normally requires a relatively high degree of torque of the electric drive.

It is an object of the present invention to disclose an actuating mechanism with improved kinematics, and which, over and above this, copes with a motor of small capacity.

This is achieved according to the invention in one embodiment in that by virtue of the transmission mechanism, the transmission ratio between the angle of rotation of the motor and the angle of rotation of the actuating arm varies across the angle of rotation range of the actuating arm.

In this way, an actuating movement can be possible which has advantageous kinematic characteristics, which—starting with the flap in the fully closed position—permits a clear reduction in the torque required, wherein the initial movement of the flap starting from the fully closed position can be effected relatively slowly. By reducing the required torque, smaller motors of less capacity and with less development of noise can be used, as a result of which there is more constructional free space due to the small space requirement. A desirable secondary effect is that upon appropriate actuation of the electric drive, the user finds that the opening movement which is initially of reduced speed is quite convenient, so that the operator can adjust himself to starting opening movement of the flap, without the initial movement occurring too quickly. This can also reduce the risk of injury.

According to an embodiment of the invention, it can be provided that the transmission mechanism is configured in such a way that the pivotal movement of the actuating arm takes place close to the two end positions of the flap with increased transmission ratio, wherein between those two end position regions a pivotal movement of the flap takes place with a lower transmission ratio, i.e. the flap moves relatively quickly across the greatest part of the range of the swing angle.

Advantageously, it can be provided that the spring device acts upon the actuating arm to such an extent that in substantially any pivot position the flap is held in position against the force of gravity. The spring device therefore expediently comprises an adjustment device by means of which the torque acting upon the actuating arm can be altered.

In order to make possible the retention force of the flap in the closed position, the flap is urged, close to the closed position, from an opening angle of less than 20°, preferably of less than 10°, by the spring device into the closed position. The flap is preferably pivotable about a horizontal axis, and it assumes a vertical position in the closed position. It is also understood that in connection with the features of the present invention, flaps or doors can also be moved which are pivotable about a vertical axis.

In order to provide the desired variable transmission, according to one embodiment of the invention a lever apparatus—in particular a toggle lever arrangement—can be used. In this respect, it can be advantageous if the toggle lever arrangement comprises at least two hingedly connected levers, preferably of different length, wherein at the free end of the shorter lever the electric drive makes contact at a stationary centre of rotation.

According to another embodiment of the invention it can be provided that the electric drive does not make contact with the main centre of rotation of the actuating arm, but is arranged eccentrically thereto. By virtue of the offset arrangement of the main centre of rotation of the actuating arm relative to the axis of the transmission mechanism to be driven by means of a motor, improved lever geometry results, thereby bringing about a significant reduction to the opening torque of the flap.

Further details and advantages of the invention will be described with the aid of the following description of the drawings, wherein:

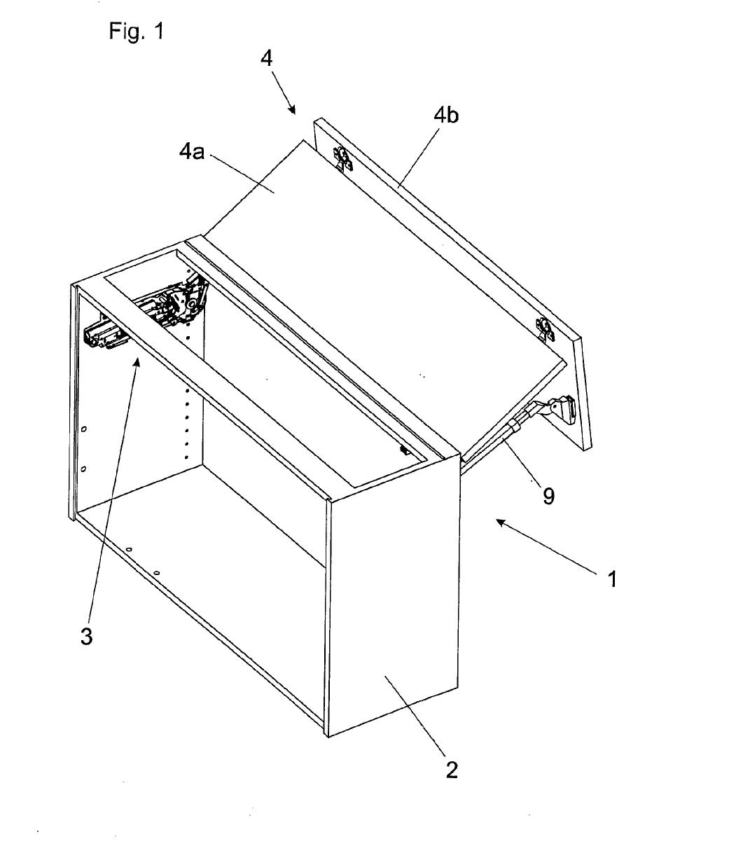

FIG. 1 is a view in perspective of an item of furniture with an actuating mechanism for a flap which can be moved upwards,

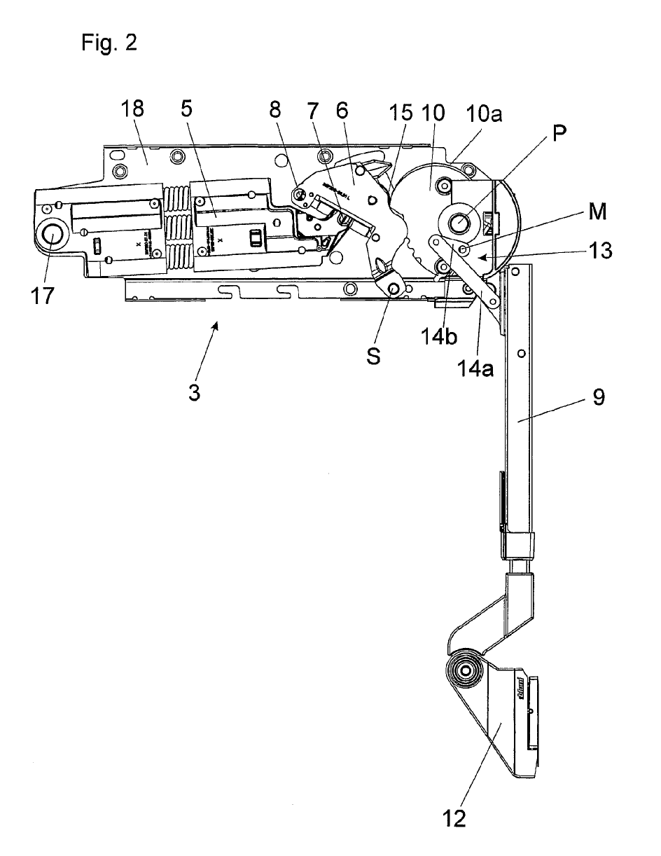

FIG. 2 is a side view of an example actuating mechanism, wherein the actuating arm is in the closed position,

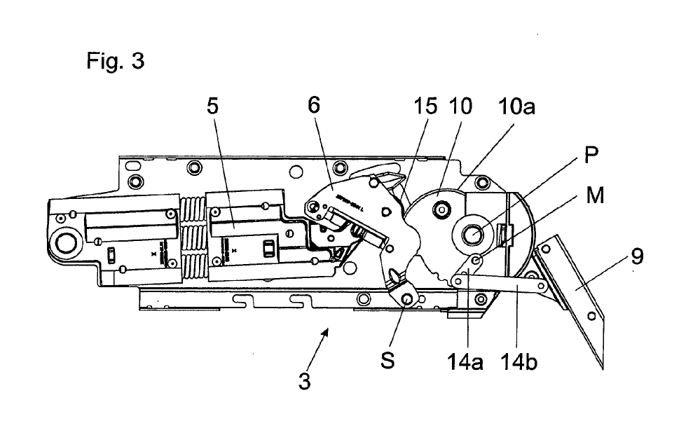

FIG. 3 shows the embodiment of FIG. 2 with the actuating arm in a slightly open position,

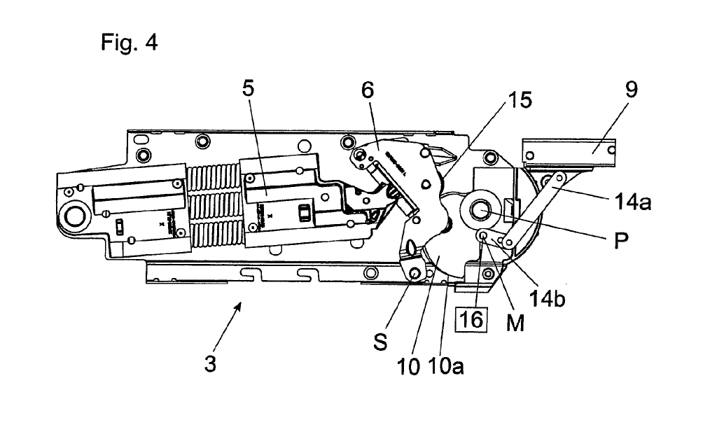

FIG. 4 shows the actuating mechanism with the actuating arm in a further open position,

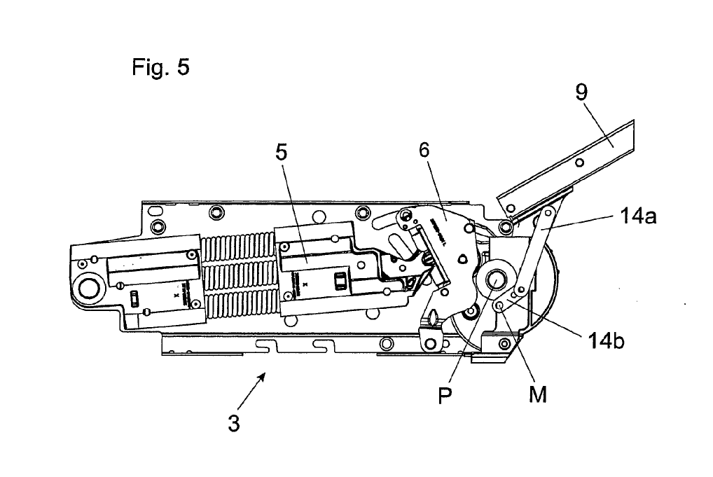

FIG. 5 shows the actuating mechanism with the actuating arm in the fully open position,

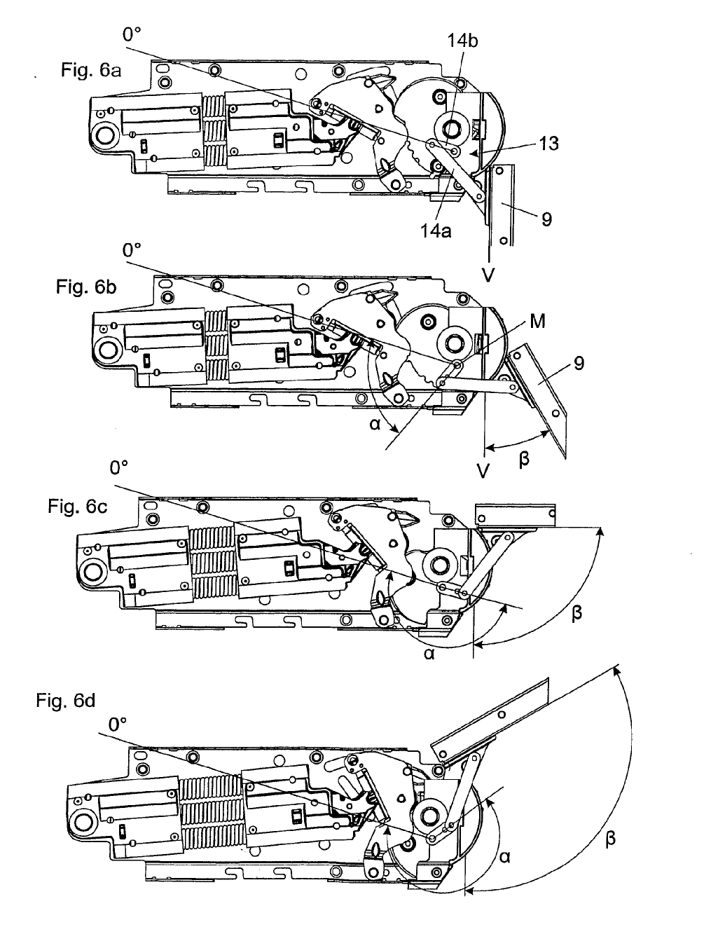

FIGS. 6a-6d show overviews of the various angles of rotation of the motor and the resultant angles of the actuating arm, and

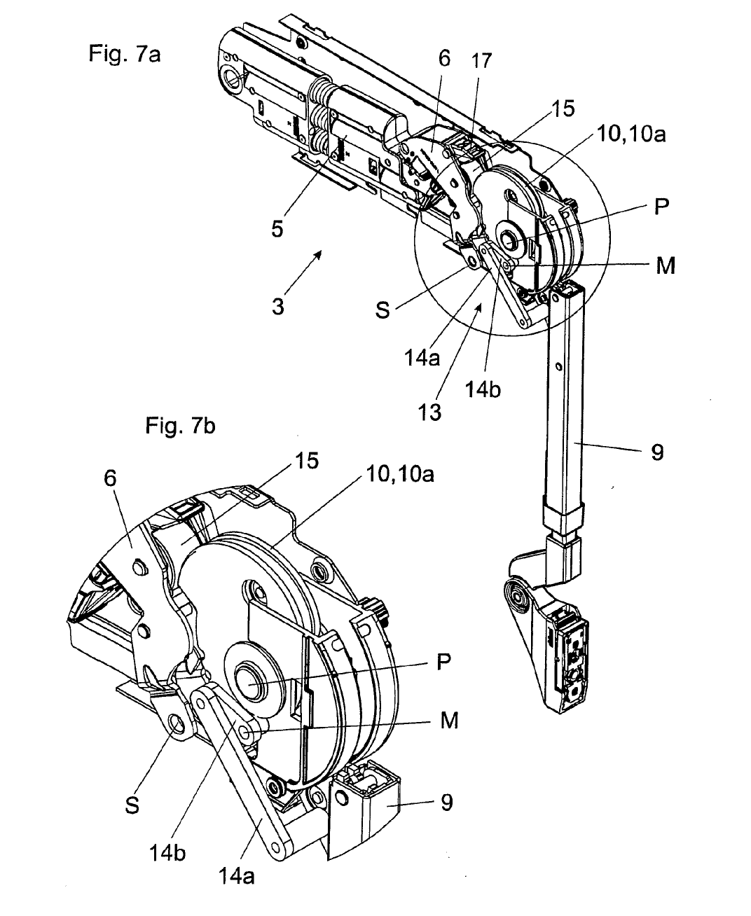

FIGS. 7a, 7b show a view in perspective of the actuating mechanism and a detailed view of it on a larger scale.

FIG. 1 shows a cabinet-like item of furniture 1 in a perspective view from the rear, which, in particular, can be used as an upper cabinet in kitchens. The item of furniture 1 comprises a furniture body 2, wherein fixed on the inside of both of the vertical side walls is a respective actuating mechanism 3 according to the invention. The actuating mechanism 3 comprises a pivotably mounted actuating arm 9 which is hingedly connected at the other end thereof to the flap 4. By means of the actuating arm 9, the flap 4 in the form of the two partial flaps 4a, 4b can be moved from the closed position into an open position, or vice versa. In the closed position, the partial flaps 4a, 4b essentially form a vertical plane, and, during opening, the partial flaps 4a, 4b fold in and form an acute angle relative to each other.

FIG. 2 shows a side view of an embodiment of an actuating mechanism 3 according to the invention. In order to balance the weight of the flap 4, not shown here, a spring device 5 is provided which comprises a plurality of compression springs arranged in parallel. The spring device 5 acts upon an intermediate lever 6 which is pivotable about the centre of rotation S, wherein the point 7 of contact of the spring device 5 on the intermediate lever 6 can be displaced by means of an adjustment device 8. In this way, the distance of the point 7 of contact of the spring device 5 relative to the centre of rotation S of the intermediate lever 6 can be altered, so that the torque which acts upon the actuating arm 9 can be adjusted for selective adaptation to flaps 4 of different weight. Arranged or formed at one end of the actuating arm 9 there is a control cam 10 which is pivotable about the centre of rotation P and which has a control curve 10a, wherein during the pivotal movement of the actuating arm 9 a pressure roller 15 mounted on the intermediate lever 6 can run along the control curve 10a of the control cam 10. The centre of rotation P thus forms the main centre of rotation of the actuating arm 9. To secure the actuating arm 9 to the flap 4 a releasable fixing device 12 is provided which can be latched to a fitting at the flap side. In the assembled condition of the actuating mechanism 3, the linearly movable spring device 5 bears against a component 17 which is fixed to the item of furniture, and acts upon the actuating arm 9 about the axis of rotation P in the opening direction of the flap 4. In the embodiment shown, the stationary component 17 is arranged on a part of the housing 18. The component 17 which is arranged stationary with respect to the item of furniture 1 forms a pivot axis for the spring device 5.

In the embodiment shown, in order to realise a variable transmission ratio of angle of rotation of the motor to angle of rotation of the actuating arm, a transmission mechanism 13 is provided in the form of a toggle lever arrangement. In the embodiment shown, the toggle lever arrangement comprises two levers 14a, 14b of different length which are hingedly connected together, wherein the shorter lever 14b is mounted eccentrically to the centre of rotation P at a centre of rotation M. The free end of the longer lever 14a is hingedly connected to the end of the actuating arm 9 remote from the flap. The longer lever 14a is at least two to three times the length of the shorter lever 14b. In the drawing shown, the actuating arm 9 is disposed in a position which corresponds essentially to the fully closed position of the flap 4.

FIG. 3 shows the actuating mechanism 3 of FIG. 2, wherein the actuating arm 9 is now in a slightly open position. By activating an electric drive, not shown here, which is preferably directly active upon the centre of rotation M of the toggle lever arrangement, the actuating arm 9 has been moved into an open position. To that end, the electric drive firstly has to overcome the retaining force of the actuating arm 9 created by the spring device 5, wherein the lever 14b rotates anti-clockwise about the stationary axis of rotation M and together with the enforcedly actuated longer lever 14a effects a relatively small pivotal movement of the actuating arm 9 at a constant revolutionary speed of the motor. The rotational movability of the lever 14b lies between 0° and 200°, preferably between 0° and 250°. The spring device 5 is advantageously so adjusted that the weight of the flap 4 is completely compensated for, i.e. the flap 4 is held automatically against the force of gravity substantially in every pivotal position.

FIG. 4 shows a further pivotal position of the actuating arm 9. The pressure roller 15 of the intermediate lever 6 runs along the control curve 10a of the control cam 10, and the actuating arm 9 rotates about the axis of rotation P. The reference numeral 16 denotes an electric drive which acts upon the axis of rotation M of the toggle lever arrangement. As a result of the changing angular position of the two levers 14a, 14b relative to each other, a controlled movement of the actuating arm 9 is made possible, wherein in this range (after having passed a lower dead center position of the toggle lever arrangement) the distance of the two free ends of the two levers 14a, 14b increases more quickly whilst the revolutionary speed of the motor remains constant, thus bringing about a correspondingly faster opening movement of the flap 4.

FIG. 5 shows the actuating mechanism 3 according to the invention, wherein the actuating arm 9 is in a position which corresponds substantially to the fully open position of the flap 4. In the region of the last opening path, decelerated movement of the actuating arm 9 once again occurs, since the toggle lever arrangement (upon approaching the upper dead center position) can extend only a small degree more. The almost stretched out toggle lever 14a, 14b can transmit very large forces in a longitudinal direction. However, it should be noted that the toggle lever 14a, 14b preferably cannot reach the fully stretched position. By means of the spring device 5 the weight of the flap is completely compensated for, and so the electric drive 16 can only be effective across a limited range of the angle of rotation (e.g. between 0° and 30°), so that the flap connected thereto is then able to move into the respective end positions without any motor support, and preferably solely by virtue of the spring device 5 acting upon the actuating arm 9.

FIGS. 6a to 6d illustrate, in an overview, various angles α of rotation of the motor and the resultant angle of rotation β of the actuating arm. In the drawings shown, a 0°-axis is respectively shown which corresponds to the orientation of the shorter lever 14b in the closed position of the actuating arm 9. This initial situation is shown in FIG. 6a, wherein the actuating arm 9 extends in the closed position substantially along the vertical axis V. In FIG. 6b, the rotatable shorter lever 14b has been pivoted anticlockwise by the motorised drive 16, not shown here, about the angle of rotation α of the motor, leading to an enforced pivotal movement of the actuating arm 9 about the actuating arm angle β. FIG. 6c shows another open position of the actuating arm 9, wherein the angle α of rotation of the motor is greater than in FIG. 6b and leads to a corresponding actuating arm angle β. FIG. 6d shows the fully open position of the actuating arm 9, with the resultant maximum angle of rotation α of the motor and the resultant angle of rotation β of the actuating arm 9. The angle of rotation β of the actuating arm 9 of FIG. 6d thus corresponds to the entire range of the actuating arm's angle of rotation.

FIG. 7a shows a perspective view of the actuating mechanism 3 according to the invention. The spring device 5 acts upon the intermediate lever 6 mounted pivotably at the axis of rotation S and which, in turn, is able to run along the control curve 10a of the control cam 10 by means of the pressure roller 15. The control cam 10 is arranged on the actuating arm 9, and rotates about the centre of rotation P. The toggle lever with the two levers 14a, 14b forms the transmission mechanism for a variable movement characteristic of the actuating arm 9. An electric drive 16, not shown here, engages on the centre of rotation M which is arranged coaxially to the centre of rotation of the shorter lever 14b. To dampen the last opening movement of the actuating arm 9 a damping device 17 in the form of a linear damper is provided which can be acted upon by a stop, not shown here, of the control cam 10 upon approach to the upper end position. FIG. 7b shows on a larger scale the region which is circled in FIG. 7a.

The present invention is not restricted to the embodiment which has been shown, but encompasses or extends to all variants and technical equivalents which can fall within the scope of the appended claims. The positional data selected in the description, e.g. top, bottom, lateral, etc., are in relation to the usual mounting position of the actuating mechanism 3, or in relation to the drawings directly described and shown, and, in the event of a change in position, should be transferred accordingly to the new position. In connection with the present invention, the term, “spring devices” is to be understood not only as spring devices 5 with mechanical spring members but also as any other known energy accumulators, such as gas pressure accumulators, or the like.

1. An actuating mechanism for moving a furniture flap, comprising:
a pivotably mounted actuating arm for moving said flap,
a spring device for acting upon said actuating arm,
an electric drive for acting on said actuating arm via a transmission mechanism,
wherein the transmission ratio between the angle of rotation (α) of the motor and the angle of rotation (β) of the actuating arm varies across the angle of the rotation range of the actuating arm by the transmission mechanism.

2. The actuating mechanism according to claim 1, wherein in the assembled state of the actuating mechanism the spring device bears against a component which is fixed to the item of furniture, and acts upon the actuating arm about an axis of rotation in the direction of opening of the flap.

3. The actuating mechanism according to claim 1, wherein the transmission mechanism comprises a lever apparatus, preferably at least one toggle lever arrangement.

4. The actuating mechanism according to claim 3, wherein the toggle lever arrangement comprises at least two hingedly connected levers, preferably of different length.

5. The actuating mechanism according to claim 4, wherein the electric drive engages at the free end of the shorter lever at a centre of rotation.

6. The actuating mechanism according to claim 5, wherein the centre of rotation of the shorter lever is arranged offset relative to the centre of rotation of the actuating arm.

7. The actuating mechanism according to claim 4, wherein the longer lever of the toggle lever arrangement engages in the region of the end of the actuating arm which is remote from the flap.

8. The actuating mechanism according to claim 1, wherein the spring device acts upon the actuating arm in such a manner that in substantially any pivot position the flap is held against the force of gravity.

9. The actuating mechanism according to claim 1, wherein the spring device acts upon the actuating arm in such a manner that close to the closed position the flap is forced into the closed position.

10. The actuating mechanism according to claim 9, wherein the spring device acts upon the actuating arm in such a manner that the flap, from an opening angle of less than 20°, preferably of less than 10°, is forced into the closed position.

11. The actuating mechanism according to claim 1, wherein the spring device has an adjustment device by means of which the torque acting upon the actuating arm can be altered.

12. The actuating mechanism according to claim 1, wherein at least one intermediate lever is provided, which, on the one hand, is acted upon by the spring device, and, which, on the other hand, rests—preferably by way of a pressure roller—against a control curve of a control cam formed or arranged on the actuating arm.

13. The actuating mechanism according to claim 12, wherein the transmission mechanism makes contact with the control cam at a centre of rotation.

14. The actuating mechanism according to claim 13, wherein the centre of rotation is arranged eccentrically relative to the axis of rotation of the actuating arm.

15. The actuating mechanism according to claim 1, wherein the electric drive comprises at least one electric motor, preferably a direct current motor.

16. The actuating mechanism according to claim 1, wherein the angle of rotation range of the actuating arm is defined between an outer end position corresponding to an open flap and an inner end position corresponding to a closed flap.

17. The actuating mechanism according to claim 1, wherein the spring device is arranged in a housing of the actuating mechanism.

18. The actuating mechanism according to claim 1, wherein the component fixed to the item of furniture is arranged on a part of a housing of the actuating mechanism.

19. The actuating mechanism according to claim 1, wherein the spring device is linearly movable.

20. An item of furniture having an actuating mechanism according to claim 1.
